(19) United States
(12) Patent Application Publication
(10) Pub. No.: US 2004/0243767 A1
(43) Pub. Date: Dec. 2, 2004

(54) Method and apparatus for prefetching based upon type identifier tags

(76) Inventors: Michal J. Cierniak, San Jose, CA (US); John P. Shen, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/453,115

(22) Filed: Jun. 2, 2003

(51) Int. Cl. G06F 12/00

(52) U.S. Cl. 711/137; 711/156

(57) ABSTRACT

A method and apparatus for prefetching based upon type identifier tags in an object-oriented programming environment is disclosed. In one embodiment, a register tag including a type identifier and a word count in a cache line may be used to populate a prefetch prediction table. The table may be used to determine correlation between fetches initiated by pointers, and may be used to prefetch to the address pointed to by the value at the word count after a fetch to the address pointed to by the type identifier.

### FIELD

The present disclosure relates generally to microprocessor systems, and more specifically to microprocessor systems capable of prefetching data or instructions into a cache.

### BACKGROUND

In order to enhance the processing throughput of microprocessors, processors typically utilize one or more levels of cache. These caches provide a faster access to selected portions of memory than the main system memory could. The disadvantage of the cache is that it is considerably smaller than system memory, and therefore considerable design effort is required to keep those portions of system memory currently needed resident in the cache. Generally new portions of system memory may be loaded into cache lines when a memory access to a cache finds the address required missing (a “cache miss”). The memory system may perform a “direct fetch” from cache in response to this cache miss.

However, waiting until program execution results in cache misses may produce reduced system performance. The program must wait until the fetch to cache is complete before proceeding. It would be advantageous to prefetch portions of system memory to the cache in anticipation of those portions being required in the near future. Prefetching must be carefully performed, as overly aggressive prefetching may replace cache lines still in use with portions of memory that may be only be used at a later time (“cache pollution”). Many existing prefetching methods may assume that data or instructions may form large contiguous blocks. With this assumption, when the data or instruction at address X is being used, the data or instruction at X+an offset may be prefetched as the assumption presumes this data or instruction may be required in the very near future.

With the increasing use of object oriented programming techniques, this assumption may no longer be valid. In object oriented programming, objects may have exemplary patterns (“class” or “type” prototypes), arrays of data to fill them, and collections of pointers to functions. This construction technique may, among other things, make both data and instructions non-contiguous within memory. For this reason, and others, existing prefetching techniques may not perform well in object oriented programs.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of the relationship of objects in a software program, according to one embodiment.

FIG. 2 is a diagram of the use of register tags in a prefetch prediction table, according to one embodiment.

FIG. 3 is a diagram of the training of a prefetch prediction table, according to one embodiment of the present disclosure.

FIG. 4 is a diagram of one adaptation to unaligned objects, according to one embodiment of the present disclosure.

FIG. 5 is a diagram of another adaptation to unaligned objects, according to one embodiment of the present disclosure.

FIG. 6 is a diagram of one adaptation to unaligned objects, according to one embodiment of the present disclosure.

FIG. 7 is a diagram of one adaptation to objects larger than a cache line, according to one embodiment of the present disclosure.

FIG. 8 is a system diagram of a multiprocessor system, according to one embodiment of the present disclosure.

### DETAILED DESCRIPTION

The following description describes techniques for prefetching in an object oriented programming envirionment. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of a particular processor and its assembly language, such as the Itanium® class machine made by Intel® (Corporation. However, the invention may be practiced in other forms of processors.

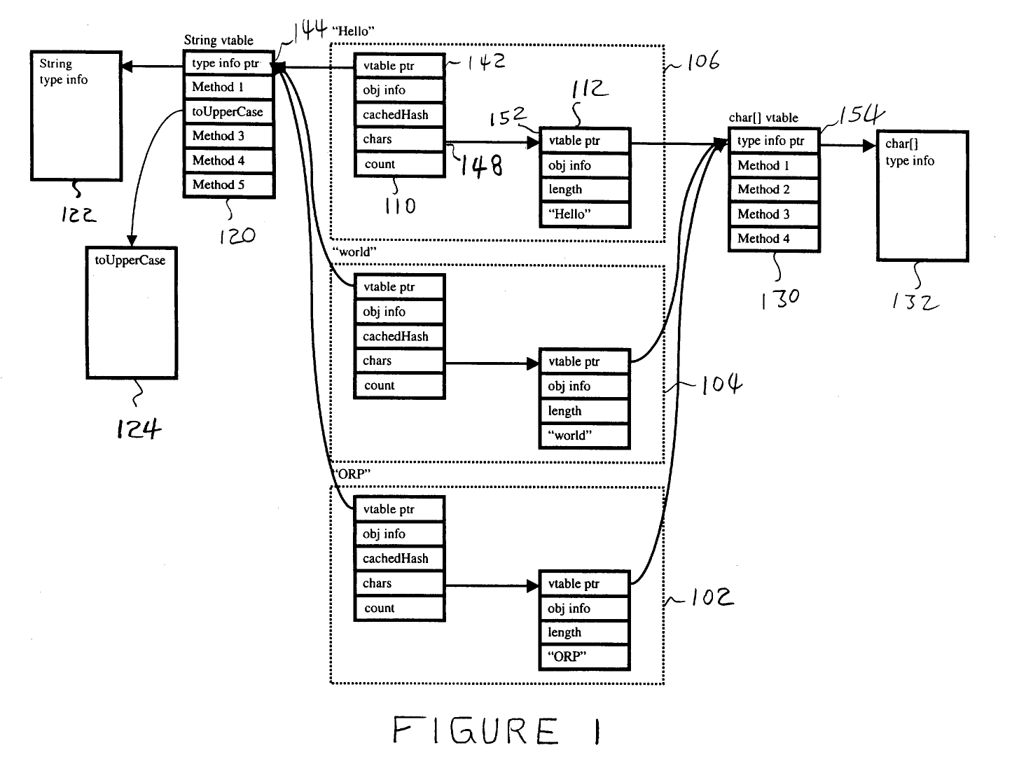

Referring now to FIG. 1, a diagram of the relationship of objects in a software program is shown, according to one embodiment. In the FIG. 1 embodiment, the objects are strings, but could be objects of other classes or types. Three simple words, “Hello” 106, “world” 104, and “ORP” 102 are represented here. One object 110 contains information about how the object 106 is to be treated. Another object 112 contains information about the actual data contents of object 106. An object is of type (or class) given by the template for that class of object, known as a virtual table or vtable. All objects of that type may therefore be treated in a similar manner. For example, object 106 is of type string, given by string vtable 120. The first location in object 106 is a vtable pointer 142 pointing to the first location in string vtable 120. Vtable pointer 142 is one example of a type identifier, wherein a type identifier uniquely identifies how an object should behave. In the case of the vtable pointer 142, it points to string vtable 120 which defines how an object of that type or class should behave.

Object 110 may also include other pointers, such as a pointer 148 to where to find the characters. In this case pointer 148 points to the first location of object 112, which in turn contains a vtable pointer 152 to the first location in a type character vtable 130. The first location in type character vtable 130 then contains a type info pointer 154 to an array of characters, char[ ] type info 132. In this manner, through multiple pointers various object may be well-defined and may have standard arrays of data available for their contents. However, FIG. 1 graphically illustrates that the data and instructions for these objects may be anything but contiguous, making existing prefetching methods potentially of little use.

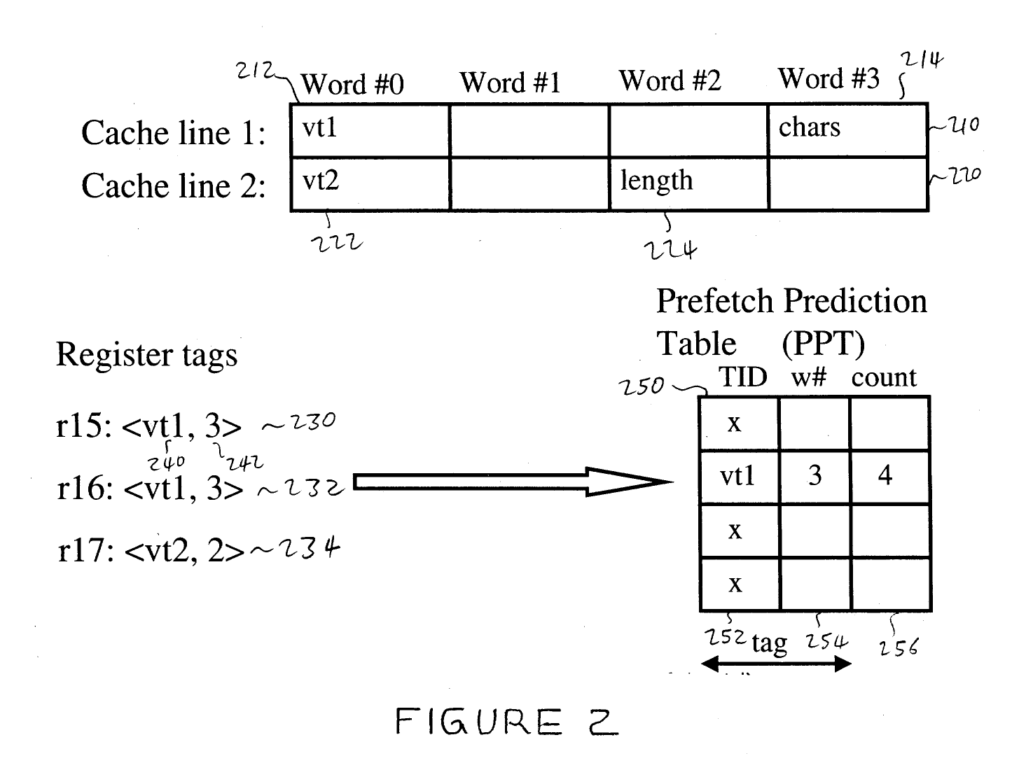

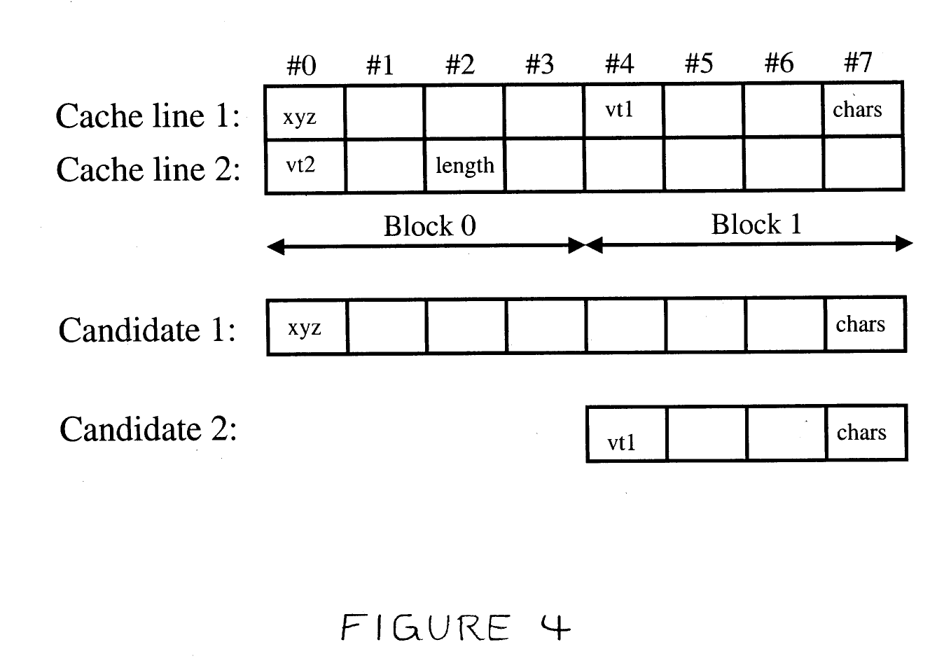

Referring now to FIG. 2, a diagram of the use of register tags in a prefetch prediction table is shown, according to one embodiment. Consider a pair of cache lines, cache line 1 210 and cache line 2 220. In the FIG. 2 embodiment, it is assumed that each object may fit within a single cache line, and that object may be aligned with the cache lines boundaries. In other embodiments, such as those discussed in connection with FIGS. 4 through 7 below, each object may not necessarily fit within a single cache line, and the objects may not be aligned with the cache line boundaries. The object 110 is shown loaded in cache line 1 210 and object 112 is shown loaded in cache line 2 220.

In one embodiment, a register tag may be associated with certain registers. For example, register tag 230 may be associated with register r15, register tag 232 may be associated with register r16, and register tag 234 may be associated with register r17. In the FIG. 2 embodiment, register tags may be implemented in hardware that may be read at any time by hardware. In other embodiments, the register tags and the information they contain may only be available for a short period of time during the load operations of the registers. In the FIG. 2 embodiment, whenever a register is loaded from a word in cache, a first part 240 may be loaded with the first word in the affected cache line and the second part 242 may be loaded with that word number of the word just loaded. For example, if the word “chars” is loaded from cache line 1 210 into register r15, then “vt1” may be loaded into the first part 240 and “3” may be loaded into the second part 230. The load instruction may be a simple load, or it may be a load to the address pointed to by the word resident in the cache line. In other embodiments, other instructions may be considered as a “load”.

When the contents of a register are moved, the register tag may move with it. For example, if the contents of r15 are moved to r16, then the contents of register tag 230 may be written into register tag 232. The move instruction may be a simple move, or a move including the addition of a constant. In other embodiments, other instructions may be considered as a “move”.

A structure called a prefetch prediction table 250 may be used to facilitate prefetching based upon historical data of program execution, or upon derived data from software analysis. The prefetch prediction table 250 may have two columns, which may be called the type identifier column 252 and the word number column 254. When a load is made to a register from a cache line, the resulting register tag may be compared with entries in prefetch prediction table. If the loaded data matches one of the entries in the type identifier column 252, then it may be useful to initiate a prefetch to the address contained in the word in that cache line corresponding to the word number in the word number column 254.

The prefetch prediction table 250 may be populated in various manners. In one embodiment, a third count column 256 may be used. When a load to a register is made, and if a match of the first part of the register tag in the type identifier column 252 and of the second part of the register tag in the corresponding entry in the word number column 254 is found, then the corresponding value in the count column 256 may be incremented. In cases where no match is found, a new entry may written into prefetch prediction table 250, with the first part of the register tag written in the type identifier column 252, the second part of the register tag written in the corresponding entry in the word number column 254, and an initialization value written in the corresponding entry in the count column 256. In one embodiment the initialization value may be 1. In one embodiment, the new entry may only be written if the first word in the cache line is found to be a type identifier, including vtable pointers. In one embodiment, when the value in the count column 256 reaches a threshold value, this may be interpreted as the establishment of a correlation between a fetch to the address of the type identifier and a subsequent fetch to the address pointed to by the value of the word at the word number in the cache line. When the threshold is reached, then it may be useful to initiate a prefetch to the address contained in the word in that cache line corresponding to the word number in the word number column 254.

In another embodiment, the prefetch prediction table 250 may be populated directly by software. In this embodiment, software analysis may be performed on the program prior to execution to determine where there exists a correlation between a fetch to the address of the type identifier and a subsequent fetch to the address pointed to by the value of the word at the word number in the cache line. In those cases where such a correlation exists, the type identifier may be written into the type identifier column 252 and the word number may be written into the word number column 254. In this embodiment the count column 256 may not be used, and the simple presence of an entry in the prefetch prediction table 250 may show that there exists a correlation between a fetch to the address of the type identifier and a subsequent fetch to the address pointed to by the value of the word at the word number in the cache line. In these cases when a load is made from an address of the type identifier, it may be useful to initiate a prefetch to the address contained in the word in that cache line corresponding to the word number in the word number column 254.

The hardware implementation of the register tags may be simplified by designs that require fewer bits. In one embodiment, an uncompressed register tag for a 64 bit processor may require 64 bits for the type identifier (an address) and, for cache lines of 64 bytes, may require 3 bits for the word number. Instead of implementing the full 64 bits for the type identifier, a compressed version of the type identifier may be used. In one embodiment, the number of bits for the type identifier may be reduced by a hashing function. For example, the hashing function may take a subset of the bits of the full address, such as the most-significant bits. In the embodiment where the software populates the prefetch prediction table 250, the number of type identifiers used in prefetching is known, and a small index to this known list of type identifiers could be used as part of the register tag.

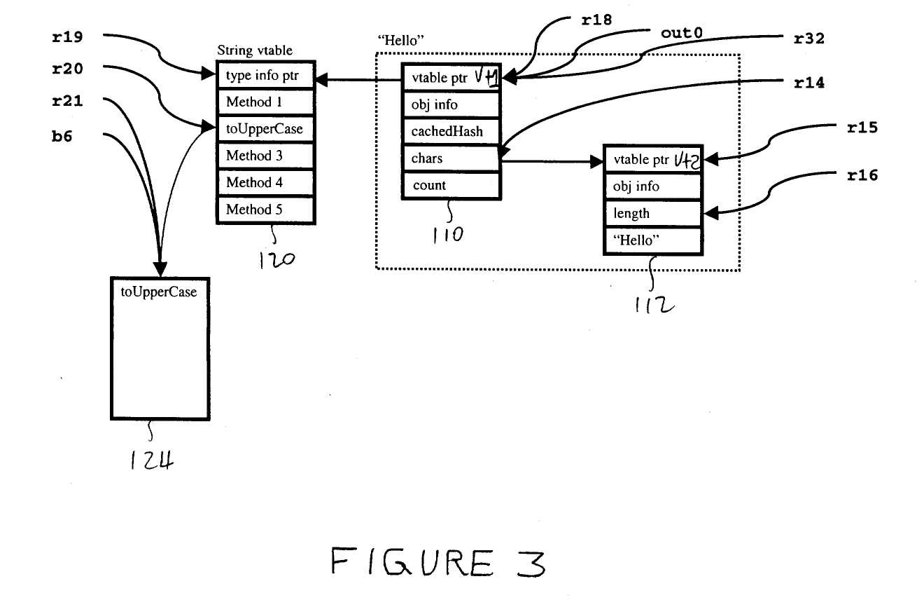

Referring now to FIG. 3, a diagram of the training of a prefetch prediction table is shown, according to one embodiment of the present disclosure. In the FIG. 3 embodiment, the prefetch prediction table 250 of FIG. 2 is discussed including the count column 256. A small piece of software represented by Source Code A and Object Code A is presented as an example of utilizing the objects given in FIG. 1 above, and in particular the populating and updating of entries in a prefetch prediction table 250.

Source Code A

String toUpperCase( )
{

char[]buf = this.chars;
int len = buf.length;

}

Object Code A

| | |
|---|---|
| add r14 = r32, 24 | // field chars is at offset 24 |
| ld r15 = [r14] | // r15 now contains the array address |
| add r16 = r15, 16 | // field length is at offset 16 |
| ld r17 = [r16] | // r17 now contains length |

Object code A presumes that the contents of r32 may contain the top of the stack (an Itanium™ architecture detail), which in the example contains the address of the first location in object 110. Thus the “add r14” instruction adds 24 bytes (3 sixty-four bit words) to the address contained in r32, and hence r14 will contain the address of word 3 in the cache line including vt1. Then the “Id r15” instruction loads “chars” into r15 because r14 contains the address of the word containing “chars”. Also the register tag of r15 is written as<vt1, 3>, because word 3 of the cache line beginning with vt1 was loaded.

The “add r16” instruction of object code A adds 16 bytes (2 sixty-four bit words) to the address contained in r15, and hence r16 will contain the address of word 2 in the cache line including vt2. Since an “add” instruction may be one of those instructions that move register tags, the register tag of r16 is copied from r5 as<vt1, 3>. Now when the “Id r17” instruction executes, r17 is loaded from the address in r16. Because of this, the register tag of r16 is compared with the entries in the prefetch prediction table 250. If there is a match, then the corresponding count is incremented. If there is not a match, then a new entry corresponding to the register tag is added to prefetch prediction table 250, with a corresponding count initialized to 1 or some other value.

A small piece of software represented by Source Code B and Object Code B is presented as another example of utilizing the objects given in FIG. 1 above, and in particular using the entries in a prefetch prediction table 250 to initiate a prefetch. The object code B may occur immediately before the object code A discussed above.

Source Code B

void F(String name)
{

String uname = name.toUpperCase( );
. . .

}

Object Code B

// assume that r18 points to string vtable
ld r19 = [r18]
// now r19 holds a vtable pointer
add r20 = r19, offset
// now r20 holds an address where the entry point
// for toUpperCase is stored in the vtable
ld r21 = [r20]
// r21 holds the entry point for toUpperCase
mov b6 = r21
mov out0 = r18
// move the THIS pointer to the out register
br.call b0 = b6
// call toUpperCase

The “id r19” instruction in object code B is a load from the address given in r18, which is a vtable pointer vt1. Because it is a load from an address, the instruction initiates a check of the entries in prefetch prediction table 250 to see if the address, vt1, matches one of the entries in the type identifier column 252. In the FIG. 2 example, there is an entry with vt1 in the type identifier column 252, and word number 3 in the word number column 254. Therefore a prefetch to the address contained in word number 3 may be initiated. In the case of prefetch prediction table 250 having a count column 256 and being trained as above by program execution, the prefetch would be initiated if the count in count column 256 was at or above a determined threshold. In the case of prefetch prediction table 250 not needing a count column 256 because prefetch prediction table 250 was populated by software analysis, the prefetch would be initiated simply by the presence of the match.

Referring now to FIG. 4, a diagram of one adaptation to unaligned objects is shown, according to one embodiment of the present disclosure. In the discussion of the FIGS. 1 through 3 embodiments, the simplifying assumption was made that the objects were aligned in the cache lines. In the FIG. 4 embodiment, the objects may be aligned in block sizes smaller than the cache lines. In one embodiment, blocks of 4 words may be used in cache lines of 8 words. Here the type identifiers may be located in the first word, word 0, or in the fifth word, word 4. Thus when a load is made to the address “chars” in word 7 of cache line 1, a register tag may either be <xyz, 7> (candidate 1) or it may be <vt1, 3> (candidate 2). Both possible register tags may be associated with the destination register, and both may generate entries in a prefetch prediction table.

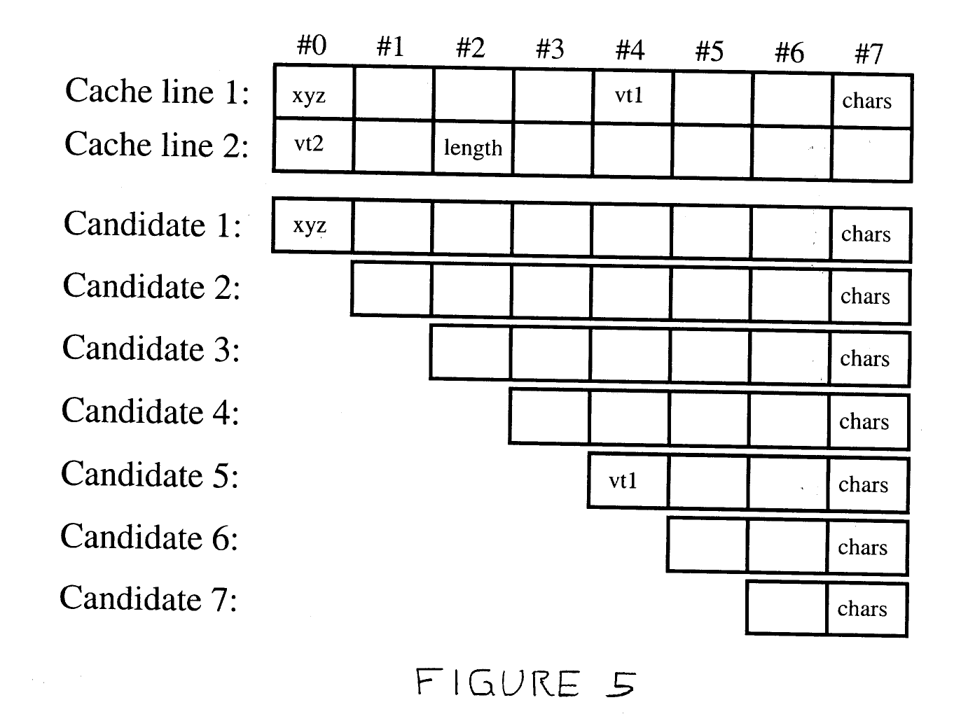

Referring now to FIG. 5, a diagram of another adaptation to unaligned objects is shown, according to one embodiment of the present disclosure. In the FIG. 5 embodiment, the block size of 1 word may be used in a cache line of 8 words. This creates a greater number of candidate register tags. In the FIG. 5 example, there are type identifiers in words 0 and 4 of cache line 1. Again both register tags may be associated with the destination register, and both may generate entries in a prefetch prediction table.

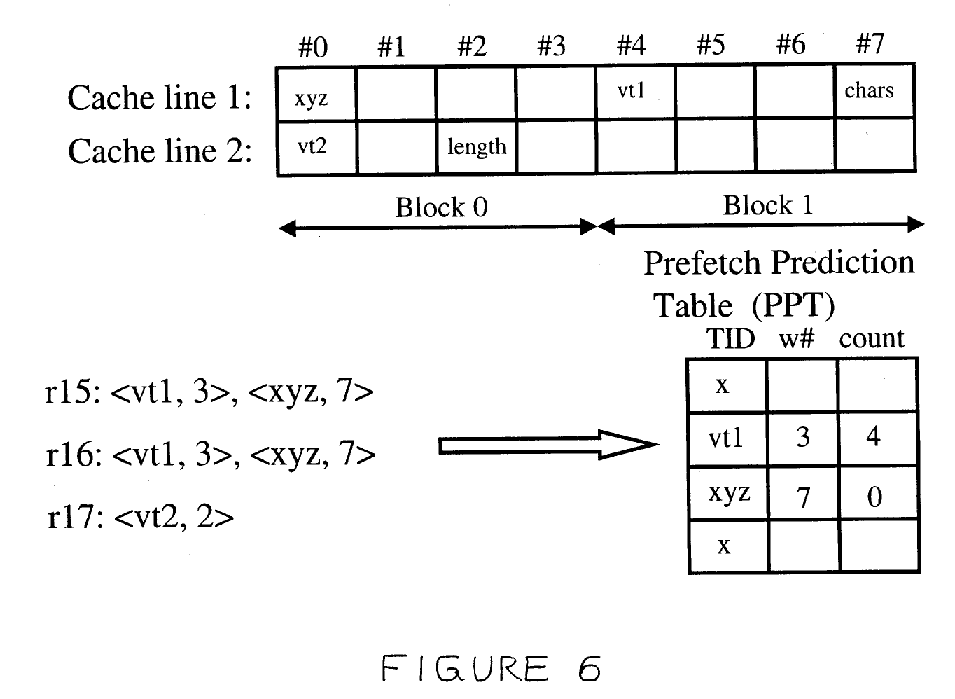

Referring now to FIG. 6, a diagram of one adaptation to unaligned objects is shown, according to one embodiment of the present disclosure. Using the FIG. 4 example, the two register tags <xyz, 7> (candidate 1) and <vt1, 3> (candidate 2) are associated with registers rl5 and r16. These may initiate corresponding entries in a prefetch prediction table. In one embodiment, the corresponding values in a count column may be incremented. In another embodiment, the entries may be placed into prefetch prediction table by software analysis. In either case, a subsequent fetch to an address contained in the type identifier column may initiate a prefetch to the address contained in the word specified by the word number in the word number column.

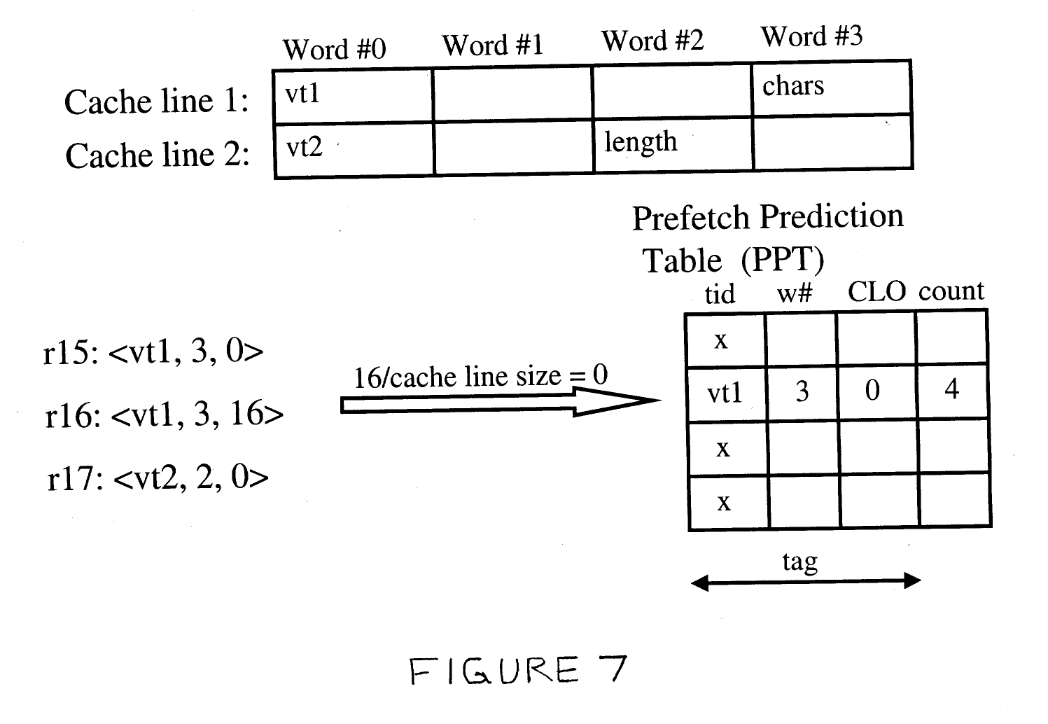

Referring now to FIG. 7, a diagram of one adaptation to support objects larger than a single cache line is shown, according to one embodiment of the present disclosure. It may be likely that the pointer of interest to a given type identifier may be located in another cache line when the object is larger than a single cache line. Therefore in one embodiment a third field, the cache line offset (CLO), may be added to the register tag. A corresponding CLO may be added in a cache line offset column of the prefetch prediction table. The CLO may represent the distance from the first address of the object. When a new entry in the prefetch prediction table is added, the CLO value may be initialized to 0. Each add of an immediate value may add the immediate operand to the CLO. Considering the object code A example, the “id r15” instruction would initialize the register tag to <vt1, 3, 0>. But “add r16” instruction would copy the first two fields of the register tag but also add the operand “16” to the CLO, yielding a register tag of <vt1, 3, 16>. During prefetching, the CLO value may be added to the effective address used for the prefetch.

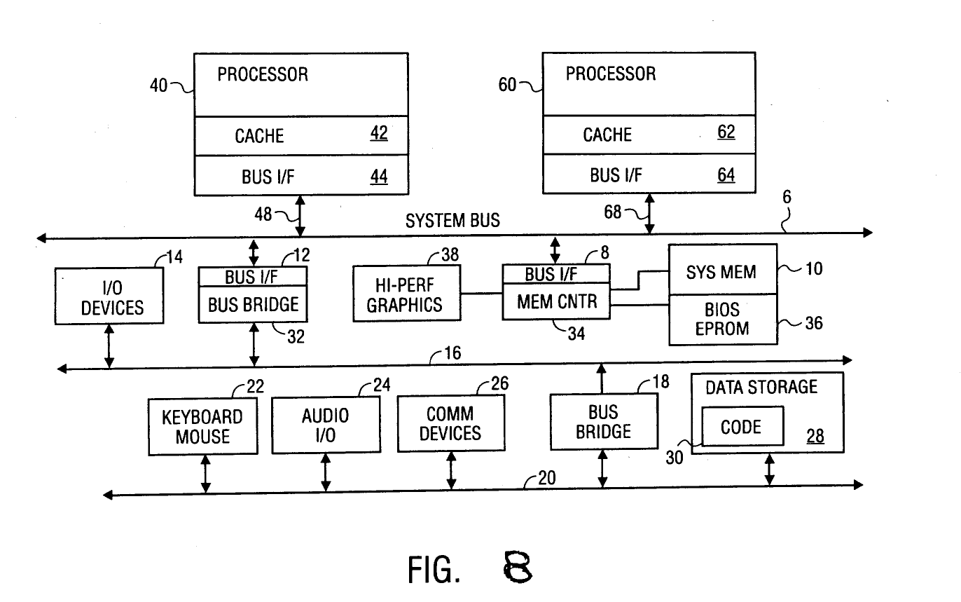

Referring now to FIG. 8, a system diagram of a multiprocessor system is shown, according to one embodiment of the present disclosure. The FIG. 8 system may include several processors of which only two, processors 40, 60 are shown for clarity. Processors 40, 60 may include the register tags and prefetch prediction table of FIG. 2. Processors 40, 60 may include caches 42, 62. The FIG. 8 multiprocessor system may have several functions connected via bus interfaces 44, 64, 12, 8 with a system bus 6. In one embodiment, system bus 6 may be the front side bus (FSB) utilized with Itanium™ class microprocessors manufactured by Intel® Corporation. A general name for a function connected via a bus interface with a system bus is an “agent”. Examples of agents are processors 40, 60, bus bridge 32, and memory controller 34. In some embodiments memory controller 34 and bus bridge 32 may collectively be referred to as a chipset. In some embodiments, functions of a chipset may be divided among physical chips differently than as shown in the FIG. 8 embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface, or an AGP interface operating at multiple speeds such as 4×AGP or 8×AGP. Memory controller 34 may direct read data from system memory 10 to the high-performance graphics circuit 38 across high-performance graphics interface 39.

Bus bridge 32 may permit data exchanges between system bus 6 and bus 16, which may in some embodiments be a industry standard architecture (ISA) bus or a peripheral component interconnect (PCI) bus. There may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
a cache memory including a cache line;
a register to be associated with a first register tag with a first part and a second part, where said first register tag contains portions of said cache line after a first load to said register from said cache line; and
a prefetch prediction table to include a first copy of said first register tag and to initiate a prefetch to a memory address pointed to by said second part of said first copy when said first load is to said first part of said first copy.

2. The apparatus of claim 1, wherein said first part is a type identifier, and said first register tag is stored in an extension of said register.

3. The apparatus of claim 1, wherein said first copy of said first register tag includes a counter incremented by a second load to said register of said second part.

4. The apparatus of claim 3, wherein prefetch is responsive to said counter reaching a threshold value.

5. The apparatus of claim 4, further comprising a second register tag stored in said extension of said register, wherein said prefetch prediction table includes a second copy of said second register tag with a third part and a fourth part.

6. The apparatus of claim 5, wherein said first part, said second part, said third part, and said fourth part are portions of said cache line.

7. The apparatus of claim 4, wherein said first register tag includes a third part, and said prefetch prediction table includes a copy of said third part to receive a cache line offset.

8. The apparatus of claim 1, wherein said first part is a type identifier, and said prefetch prediction table to be initialized by software execution.

9. The apparatus of claim 8, wherein said software execution preloads said prefetch prediction table with a first value for said type identifier and a second value for a corresponding second part predetermined by software to permit prefetching.

10. The apparatus of claim 1, wherein said first part is a vtable pointer.

11. A method, comprising:
selecting a tag identifier and a word number of a cache line associated with said tag identifier;
determining whether a second fetch to a second address pointed to by a value of said word number is correlated to a first fetch to a first address pointed to by said tag identifier; and
if so, then prefetching to said second address after each load to said first address.

12. The method of claim 11, wherein said selecting includes associating said tag identifier and said word number to a register when said register loads from said word number in said cache line.

13. The method of claim 12, wherein said associating includes writing said tag identifier and said word number to a register extension.

14. The method of claim 13, wherein said determining includes incrementing a counter when a second fetch to a second address pointed to by a value of said word number is correlated to a first fetch to a first address pointed to by said tag identifier.

15. The method of claim 12, wherein said determining includes initializing a prefetch prediction table by software.

16. The method of claim 15, wherein said determining includes comparing said tag identifier and said word number to said prefetch prediction table.

17. An apparatus, comprising:
means for selecting a tag identifier and a word number of a cache line associated with said tag identifier;
means for determining whether a second fetch to a second address pointed to by a value of said word number is correlated to a first fetch to a first address pointed to by said tag identifier; and
if so, then means for prefetching to said second address after each load to said first address.

18. The apparatus of claim 17, wherein said means for selecting includes means for associating said tag identifier and said word number to a register when said register loads from said word number in said cache line.

19. The apparatus of claim 18, wherein said means for associating includes means for writing said tag identifier and said word number to a register extension.

20. The apparatus of claim 19, wherein said determining includes incrementing a counter when a second fetch to a second address pointed to by a value of said word number is correlated to a first fetch to a first address pointed to by said tag identifier.

21. The method of claim 18, wherein said means for determining includes means for initializing a prefetch prediction table by software.

22. The method of claim 21, wherein said means for determining includes means for comparing said tag identifier and said word number to said prefetch prediction table.

23. A computer-readable media including software instructions that when executed by a processor perform the following:
selecting a tag identifier and a word number of a cache line associated with said tag identifier;
determining whether a second fetch to a second address pointed to by a value of said word number is correlated to a first fetch to a first address pointed to by said tag identifier; and
if so, then indicating that a prefetch should occur to said second address after each load to said first address.

24. The computer-readable media of claim 23, wherein said selecting includes associating said tag identifier and said word number to a register when it is determined that said register may load from said word number in said cache line.

25. The method of claim 23, wherein said determining includes initializing a prefetch prediction table by software.

26. The method of claim 25, wherein said determining includes comparing said tag identifier and said word number to said prefetch prediction table.

27. A system, comprising:
a processor including a cache memory including a cache line, a register to be associated with a first register tag with a first part and a second part, where said first register tag contains portions of said cache line after a first load to said register from said cache line and a prefetch prediction table to include a first copy of said first register tag and to initiate a prefetch to a memory address pointed to by said second part of said first copy when said first load is to said first part of said first copy;
a bus coupled to said processor; and
an audio input/output coupled to said bus.

28. The system of claim 27, wherein said first part is a type identifier, and said first register tag is stored in an extension of said register.

29. The system of claim 28, wherein said first copy of said first register tag includes a counter incremented by a second load to said register of said second part.

30. The system of claim 29, wherein prefetch is responsive to said counter reaching a threshold value.
